(19) United States
(12) Patent Application Publication
(10) Pub. No.: US 2026/0051994 A1
(43) Pub. Date: Feb. 19, 2026

(54) METHODS AND APPARATUS TO ADAPT DEMODULATION REFERENCE SIGNAL DENSITY BASED ON EXPLICIT FEEDBACK IN WIRELESS COMMUNICATION NETWORKS

(71) Applicant: Continental Automotive Technologies GmbH, Hannover (DE)

(72) Inventors: Reuben George Stephen, Singapore (SG); David Gonzalez Gonzalez, Egelsbach (DE); Rikin Shah, Langen (DE); Andreas Andrae, Frankfurt am Main (DE); Hojin Kim, Regensburg (DE)

(73) Assignee: Continental Automotive Technologies GmbH, Hannover (DE)

(21) Appl. No.: 19/102,357

(22) PCT Filed: Aug. 7, 2023
(86) PCT No.: PCT/EP2023/071825

§ 371 Date: Feb. 7, 2025

(30) Foreign Application Priority Data
Aug. 8, 2022 (DE) 10 2022 208 202.8

(51) Int. Cl. H04L 5/00; H04L 1/1829

(52) U.S. Cl. CPC H04L 5/0051; H04L 1/1864; H04L 5/0064

(57) ABSTRACT

Demodulation Reference Signal (DM-RS) density is adapted in wireless communication networks. A receiver, especially a user equipment (UE), submits a request to a transmitter, especially to a base station, to change the DM-RS density. The transmitter monitors feedback of the receiver relating to the quality of reception. And the transmitter decides, in dependence of the feedback, whether to indicate a change of DM-RS.

### CROSS-REFERENCE TO RELATED APPLICATIONS

The present application is a National Stage Application under 35 U.S.C. § 371 of International Patent Application No. PCT/EP2023/071825 filed on Aug. 7, 2023, and claims priority from German Patent Application No. 10 2022 208 202.8 filed on Aug. 8, 2022, in the German Patent and Trademark Office, the disclosures of which are herein incorporated by reference in their entireties.

### TECHNICAL FIELD

There are different types of Reference Signals (RSS) used in the 3GPP 5G NR and beyond systems. This invention focusses on demodulation reference signal (DM-RS) transmission by the transmitter during the course of communication with a receiver, which aids the receiver in decoding data. The DM-RS takes up one or more symbols within a slot. It is used for channel estimation at the device for coherent demodulation. Thereby the receiver would not be able to decode the data packet with satisfactory error performance if the DM-RS is not received with sufficient signal strength. In the downlink (DL), the DM-RSs are present in the resource blocks used for the physical downlink shared channel (PDSCH) transmission and also in the physical downlink control channel (PDCCH). In the uplink (UL), the DM-RSs are present in the physical uplink shared channel (PUSCH) which allows the gNB to coherently demodulate the uplink data in the PUSCH and also in the physical uplink control channel (PUCCH). Finally, in the sidelink (SL) the DM-RS are present in both the physical sidelink shared channel (PSSCH) and the physical sidelink control channel (PSCCH).

Since DM-RS themselves do not carry any useful data, it is desirable to reduce or to adapt their transmission according to the requirement of the receiver. In current 3GPP specifications, the possibility of such adaptation is limited. In particular, if the receiver has channel prediction capability or can decode data blindly (i.e. without estimating the channel using DM-RS first) then it may not require DM-RS transmission by the transmitter. Consequently, density of DM-RS could be reduced or avoided completely. On the other hand, if the receiver believes it needs larger accuracy, the density of DM-RS needs to be increased.

Previously known DM-RS density change is based on HARQ ACK/NACK feedback or on Doppler frequency and/or rate of change of channel characteristics, whereby HARQ ACK/NACK feedback alone is not sufficient to determine channel prediction capability at UE. For example, US 2021028903 A1, US 2020313818 A1 and US 2021226833 A1 disclose methods of such feedback.

The object of the present invention is to propose an efficient way to constitute a change of DM-RS density during a communication between a receiver and a transmitter.

The invention is described by the features of the independent claims. Advantageous embodiments could be found in the respective sub claims.

### BRIEF SUMMARY

In summary, one central part of the inventive idea is to change the DM-RS density, especially to reduce DM-RS density if possible even to zero, by request of the receiver, e.g., the user equipment (UE). When such a request is submitted, the transmitter, e.g., the base station (e.g. gNB), monitors the quality of feedback from the receiver including the HARQ response, and decides on basis of this feedback about signaling or indicating the requested DM-RS density change.

Thereby the request of the receiver might be based on its blind decoding capability or on its own channel prediction capability. Thereby blind decoding capability means that UE is able to decode data without knowing the channel state information (CSI) which is typically facilitated by the transmission and reception of the DM-RS. Methods of blind decoding as well as channel prediction are known from the state of the art. Channel prediction and blind decoding capabilities can be enhanced with use of Artificial Intelligence (AI) or Machine Learning (ML) techniques.

In the first case (blind decoding) the receiver might request a complete turn off of the DM-RS signals and sends—while blind decoding—feedback only in the form of HARQ ACK/NACK to the transmitter, e.g., the base station. On the basis of the feedback potentially in combination with other favorable conditions, the transmitter decides about the request. Thereby the transmitter indicates to turn off DM-RS signals—as requested—in case of ACK feedback or the transmitter indicates to restore DM-RS if it receives one or more NACK.

Independent from a request, if the actual DM-RS density is zero and the transmitter receives “bad” feedback, i.e. one or more NACK, the transmitter may take every time the decision to increase the DM-RS density.

In second case (channel prediction) the receiver evaluates prediction accuracy on known RSs with current DM-RS density. Based on this evaluation the receiver sends a request to the transmitter e.g., via the PUCCH or PUSCH for the downlink communication feedback by a UE to the gNB, via the PSSCH or PSCCH for the sidelink communication feedback by a UE to another UE, or even via the PDCCH or PDSCH for the uplink communication feedback by a gNB to the UE to change the current DM-RS density (or not). The indication may be based on a mapping between the error regions evaluation and the DM-RS densities. Then, this mapping is known beforehand at the receiver via pre-configuration between the transmitter and the receiver or a system information message sent by the network to the UE or fixed in the specification. Thereby, in case of a change in DM-RS signal density, the receiver uses the new DM-RS density when performing data demodulation.

With that, in scenarios where the receiver has channel prediction or blind decoding capability, the proposed invention gives a system and methods to adapt DM-RS density or remove DM-RS transmission altogether by the transmitter, based on explicit feedback by the receiver. Thereby, the reduction of DM-RS transmission is always advantageous since it increases achievable data rate.

So, if the receiver believes it can predict the channel accurately or uses blind decoding, the density of DM-RS can be reduced or the DM-RS can be avoided completely. On the other hand, if the UE believes it needs larger accuracy, it may use the same mechanisms to request an increase of the DM-RS density.

Whether the receiver uses blind decoding or channel prediction is not essential to the invention. It is important, that the receiver can either request to turn off the DM-RS or request for a change in the DM-RS density. This can be based on any capabilities of the receiver, which the transmitter need not know explicitly. Blind decoding and especially AI/ML based channel prediction are examples for receiver capabilities.

Currently DL and UL DM-RS is always configured by gNB whereby the UE has no say in time and frequency-domain layout of DM-RS. Similarly, in the SL, the DM-RS configurations are fixed in the specifications. With the invention, the receiver may use its capability of blind decoding (with classical or AI/ML-based methods) or channel prediction (classical or AI/ML-based methods) to influence the layout.

The inventive method is performed by a system comprising a receiver, especially a UE, equipped with means for submitting a request for changing the DM-RS density to a transmitter, especially to the base station, and a transmitter equipped with means for monitoring feedback of the receiver relating to the quality of reception, and equipped with decision means for deciding in dependence of the feedback whether to indicate a change of DM-RS.

Another aspect of the invention is to propose a set of pre-defined DM-RS patterns with different time and frequency-domain densities and signaling methods, whereby the transmitter and the receiver are able to switch between them. It also includes a channel prediction error evaluation method by the receiver to aid the switching between different DM-RS density patterns. So, a systematic framework of ordered time and frequency-domain DM-RS densities can replace or complement existing DM-RS formats

Following the invention is explained with respect to the downlink (DL) but it is also possible for the uplink (UL) and sidelink (SL). For implementing the invention, the gNB and UE(s) have to be prepared to use flexible DM-RS time/frequency densities.

### BRIEF DESCRIPTION OF THE DRAWINGS

Other advantages and characteristics of the invention will be more clearly apparent on reading the following description, given by way of simple illustrative and no limiting example, and the appended drawings.

FIG. 1 illustrates inventive steps performed by UE and gNB.

FIG. 2 is a flow chart depicting main steps under perspective of a UE.

FIG. 3 is a flow chart depicting main steps under perspective of a gNB.

FIG. 4 illustrates DM-RS Formats.

FIG. 5 illustrates DM-RS Initial Pattern.

FIG. 6 illustrates DM-RS Pattern Representation Option 1.

FIG. 7 illustrates DM-RS Pattern Representation Option 2.

FIG. 8 illustrates a further DM-RS Pattern Representation Option 2.

FIG. 9 illustrates a mapping from Error Evaluation to DM-RS Density.

FIG. 10 illustrates mapping from Error to DM-RS Density Option 1.

FIG. 11 illustrates mapping from Error to DM-RS Density Option 2.

FIG. 12 illustrates an indication by UE Option 1.

FIG. 13 illustrates an indication by UE Option 2.

FIG. 14 illustrates an indication by UE Option 2.1.

FIG. 15 illustrates an indication by UE Option 2.2.

FIG. 16 illustrates an example of indication by UE Option 2.2.

### DETAILED DESCRIPTION

The detailed description set forth below, with reference to annexed drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In particular, although terminology from 3GPP 5G NR may be used in this disclosure to exemplify embodiments herein, this should not be seen as limiting the scope of the invention.

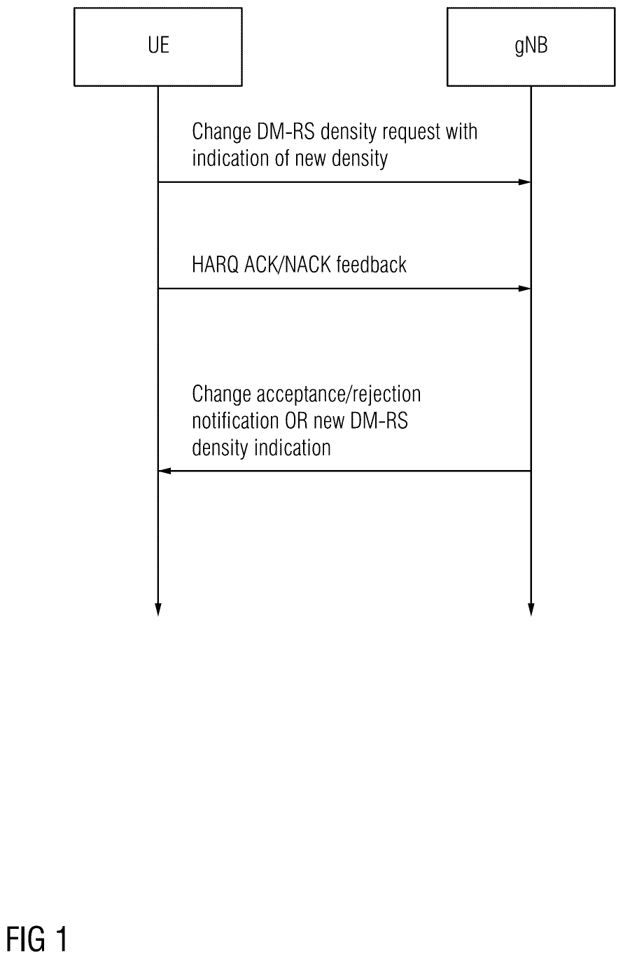

FIG. 1 shows the inventive exchange of messages on an exemplary 5G New Radio (NR) wireless communication system comprising a user equipment (UE) and a base station (gNB). The wireless network may be an LTE network or some other wireless network, such as LTE, 5G or NR network. The wireless network may include one or more base stations. The base station may be referred as BS, NB, eNodeB (or eNB), gNodeB (or gNB), an access point or the like, depending on the wireless standard implemented. Base station provides radio communication coverage for a particular cell.

User equipment may be referred as a mobile station, a wireless terminal, or the like. In some examples, user equipment may be a cellular phone, a wireless modem, a wireless communication device, a handheld device, a laptop computer or the like. User equipment may also be an IoT (internet of things) device, like wireless camera, a smart sensor or smart meter, a vehicle, a global positioning system device, or any other device configured to communicate through a wireless network.

In FIG. 1 it is illustrated, that UE 101 in a first step 102 sends gNB 103 a request to change, especially to decrease, the DM-RS density. In case UE has the possibility to perform blind decoding, it may request to turn off DM-RS signals. Otherwise when UE has channel prediction capabilities, the UE may request to decrease DM-RS to a certain pattern. Meanwhile UE continues to send HARQ ACK/NACK feedback to gNB 104, which continues monitoring that HARQ feedback. On the basis of the HARQ feedback and potentially in combination with other feedback from the UE (e.g., channel state information feedback), the gNB examines whether the request to change DM-RS density is feasible. Depending of the result of that examination, gNB sends in step 105 a notification to UE that the requested change is accepted or that the request is rejected. In case the gNB decides that the request is not feasible, it may decide that an alternative DM-RS density is feasible. Than gNB sends a respective notification with that new DM-RS density indication to UE.

In case UE uses channel prediction, it evaluates its prediction accuracy on known RSs (with current DM-RS density). Based on that evaluation, UE sends indication to gNB (via PUCCH/PUSCH) to change current DM-RS density (or not). This indication may be based on a mapping between error values and DM-RS densities, which is known beforehand at both the UE and the gNB via pre-configuration or a system information message sent by the gNB to the UE, or due to being fixed in the specification.

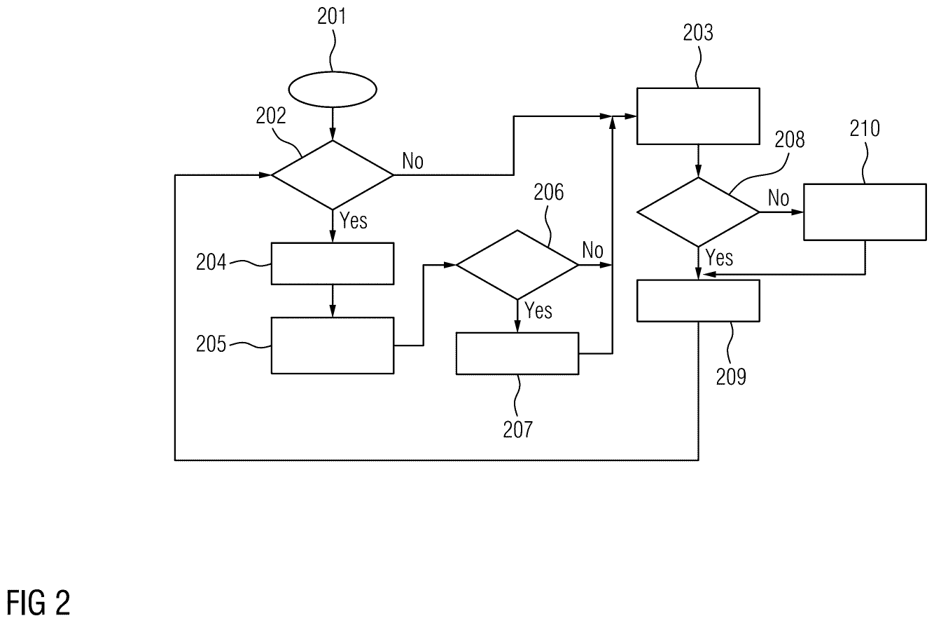

FIG. 2 is a flow chart depicting main steps of a state machine suitable for implementing the invention in a user equipment (UE). The state machine starts at 201. In 202 UE examines, if a change in DM-RS format, especially in DM-RS density, is required. In case of “No” the UE continues performing data demodulation according to the current DM-RS format at 203. In case of “Yes”, the UE requests a change in DM-RS density at gNB at step 204 and continues sending HARQ response to gNB according to the usual HARQ process, until an indication from the gNB is received at step 205 whether a change in DM-RS density should happen. Then the UE checks in 206 if the change in DM-RS density is successful which means if a change is indicated by the gNB or not. In case no change is indicated, UE continues performing data demodulation with the current format at 203, which is the old format. If gNB has indicated a change, UE updates the internal DM-RS format at step 207 and performs data demodulation with the “current” format at 203, which is now the new format.

At step 208 checks the UE whether the current format has a DM-RS density of zero. If “Yes”, UE performs at step 209 feedback according to the usual HARQ process. If current density is different to zero, the UE first evaluates at 210 the channel prediction error with current DM-RS format and then performs the HARQ process in 209. The feedback at 209 affects the examination at step 202, whether a change in DM-RS format is required. The feedback by the UE maybe performed in the physical uplink control channel (PUCCH) or by suitable physical uplink shared channel (PUSCH) resources provided by the gNB.

Advantageous methods of updating DM-RS by UE are described following: On receiving indication on DM-RS density change from gNB for example in Downlink Control Information (DCI), the UE updates its own current DM-RS density as follows. In case the current DM-RS density is zero, and the gNB uses a binary indication, the UE switches to default DM-RS density if the change is accepted by the gNB. Else, it retains the current DM-RS density of zero. On the other hand, if the current DM-RS density is zero and the gNB uses a multiple bit indication, the UE switches to respective DM-RS density pattern indicated by those bits. In case the current DM-RS density at the UE is non-zero, and the gNB is using a binary indication, the UE switches to the DM-RS density it requested in last uplink control information (UCI) transmission. On the other hand, if the current DM-RS density is non-zero and the gNB is using a multiple bit indication, the UE switches to the corresponding DM-RS density indicated by the bits.

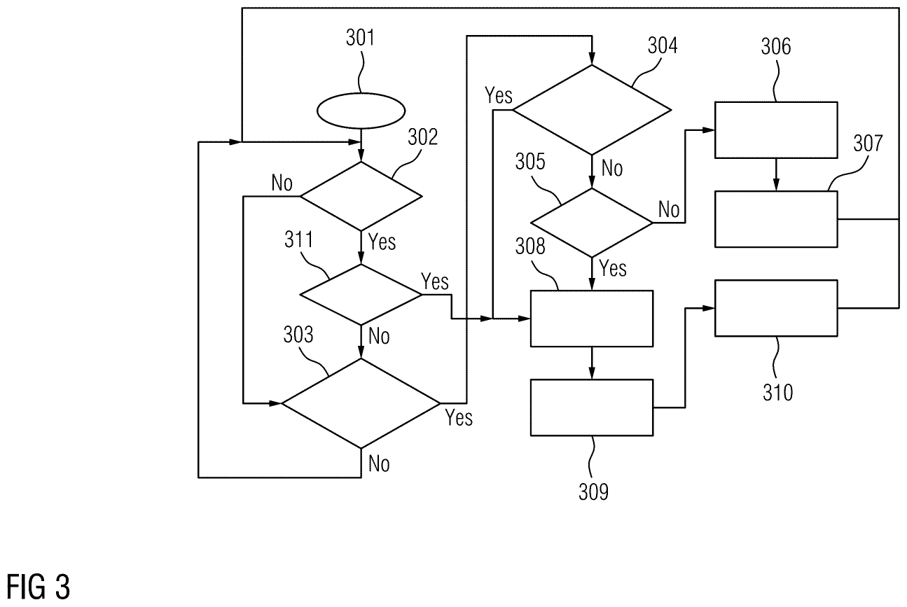

FIG. 3 is a flow chart characterizing the steps of the counterpart, i.e. the base station (e.g. gNB), starting at point 301. In the first step 302, the gNB as transmitter checks, whether the current DM-RS density is zero. If not (“No”), the gNB scans in step 303 whether there is a submission of the UE, whereby when a submission has received, gNB checks whether this contains a request for changing the DM-RS density. As long as both is “No”, the gNB remains in a loop beginning with the “zero density” check at 302. If a request is received by the gNB, it leaves the scan in 303 with “Yes” and continues with the evaluation at 304, whether the requested change is feasible. If the requested change is not feasible, the gNB investigates in 305 if an alternative change of DM-RS would be feasible. If also “No” the gNB indicates the UE in step 306 that no change in DM-RS could happen and the gNB continues transmitting in step 307 with the “old” DM-RS density in the next schedule. Then the gNB returns to the first step 302.

If the check in step 305 results in that the alternative change of DM-RS would be feasible then the gNB continues with updating DM-RS density for the UE with step 308 before indicating the change to UE by step 309 and transmitting with new DM-RS density in the next schedule (step 310). Then the gNB returns to the start at step 302.

If in step 304 the gNB finds that the requested DM-RS density is feasible (“Yes”) than gNB updates the density to the requested value in step 308 and continues as described above.

If in step 302 the gNB finds that the current density is zero (“Yes”) than gNB checks in 311 whether it receives NACKs from UE. If “Yes”, gNB decides to update. i.e. to increase, the DM-RS density for UE in step 308 even without an explicit request from the UE and continues as described above. Otherwise, if no NACKs are received by the gNB, it jumps to step 303 and scans whether a request has received. If “No”, gNB starts again with the “zero check” at 302.

Advantageous methods of indicating by gNB are described following: When receiving a DM-RS density change request from UE, gNB evaluates the feasibility of a new pattern advantageously in dependence on patterns used for other users. After evaluation, gNB may use one of the following two options for indication to UE. First is a binary indication which indicates if requested DM-RS density is accepted or not. Such a binary indication has low overhead but less flexibility. An indication with multiple bits may indicate indices for updating DM-RS density. This solution has more overhead but more flexibility.

If case the current DM-RS density for UE is zero and gNB did not receive DM-RS density change request from UE, gNB proceeds monitoring HARQ ACK/NACK and may decide to change DM-RS density with the following two options for indication: Again, a binary indication is possible if DM-RS density should be changed to a default or an initial density or should not be changed. This solution has low overhead but respectively less flexibility. With multiple bits it is possible to indicate an index for new DM-RS density with higher overhead but more flexibility. Generally, it is possible that gNB indications above can be signaled in DCI using one or more bits.

A complete implementation requires specifying new DM-RS formats and indication methods, but the methods can also be implemented in restricted way within current DM-RS framework of 3GPP. Thereby, UE evaluates error in prediction as outlined using for example a table mapping errors to currently available DM-RS formats (single or double symbol DM-RS and number of DM-RS occasions in slot). The UE may feedback an indication to increase or decrease the number of DM-RS occasions or may indicate required number of DM-RS occasions. The UE may also indicate change from single to double symbol DM-RS or vice-versa.

Implementing the inventive method, gNB may indicate the new DM-RS format by changing the parameters “maxLength” and “dmrs-AdditionalPosition” in the “DMRSDownlinkConfig” information element (IE) (see 3GPP TS 38.331, pg. 424, 425 for details).

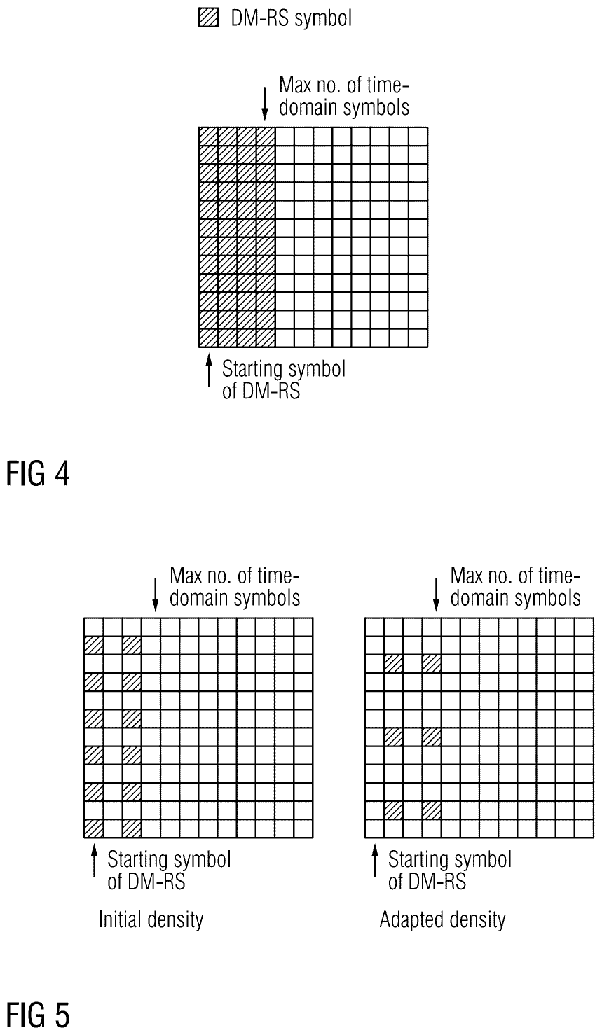

FIG. 4 shows DM-RS Formats which could be defined with varying densities in the time and frequency domains. Thereby a starting symbol and a maximum number of symbols for DM-RS defines the boundaries of the DM-RS occasion. Starting symbol can be indicated with respect to the slot boundary or the first data symbol. (Type A or Type B as in current specifications).

FIG. 5 shows DM-RS examples of initial pattern as could be assigned by gNB. This initial pattern is fixed for a particular combination of starting symbol and for the maximum number of symbols. The initial pattern could be fixed in the specification which is less complex or could be semi-statically indicated to the UE which involves signaling overhead. Within the time-frequency block determined by the starting symbol and the maximum number of symbols, the UE can flexibly feedback the required DM-RS density pattern.

For each combination of starting symbol and maximum number of symbols a set of ordered patterns, from minimum to maximum density, could be defined. This might be done in two ways. First is specifying and signaling a unique index for each pattern in the set. Second is specifying a set of patterns “adjacent” to each pattern. In the second method, the gNB may indicate an initial pattern, which ideally should have intermediate density.

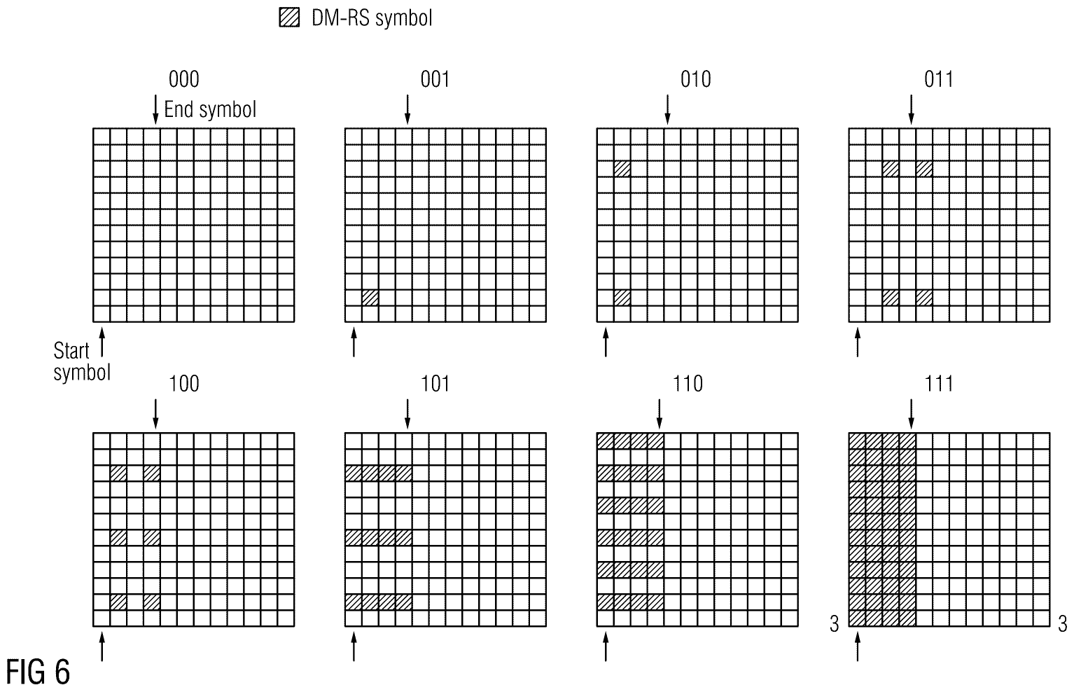

FIG. 6 shows an example of the first option of the DM-RS pattern representation. As could be seen in the figure, each individual pattern is assigned by an index (“000” . . . “111”) of a codebook. Thereby the DM-RS pattern codebook can be fixed for all UEs which means least overhead but also no flexibility. Otherwise, it can be fixed for each type(s) of UEs which means no overhead and some flexibility. Further it can be indicated to each UE e.g., via semi-static signaling. This solution requires considerable overhead but allows much flexibility.

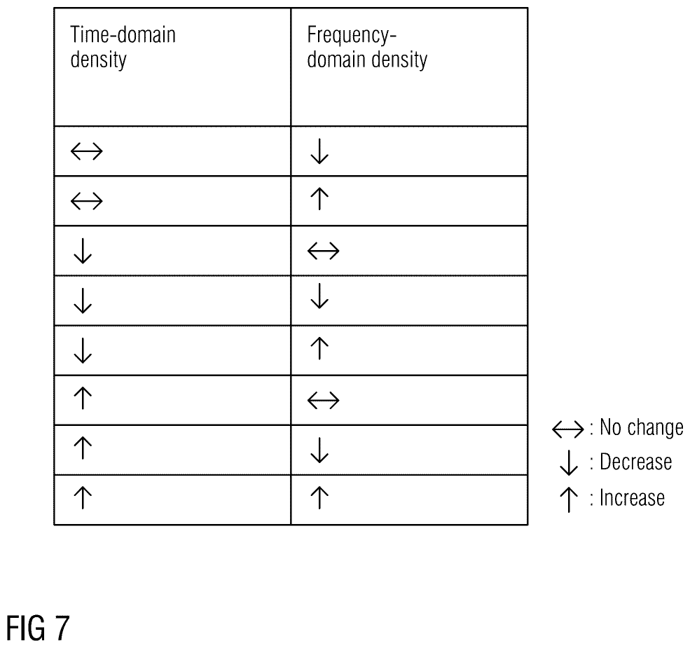

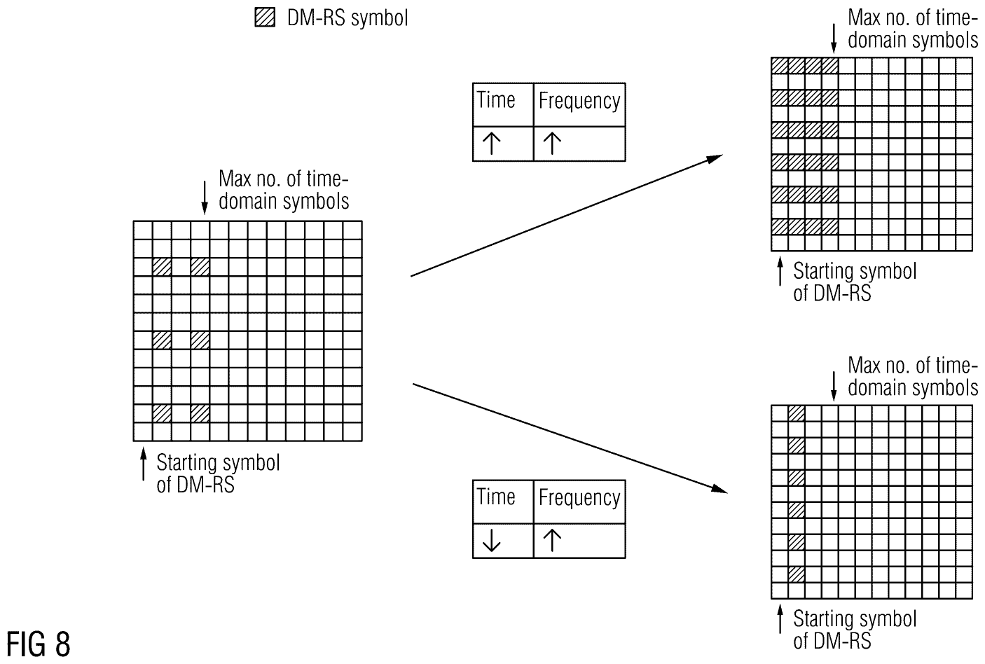

FIG. 7 shows an example of the second option of the DM-RS pattern representation as, whereby for each defined pattern there can be eight other unique patterns corresponding to changes in time or in frequency-domain density of DM-RS. Again, these changes could either be fixed in the specifications which means no signaling overhead or semi-statically indicated with signaling overhead. In the shown table “↑” means an increase, “↓” means a decrease and “↔” means no change. An example of this second option is illustrated in FIG. 8.

Concerning channel prediction and error evaluation the UE is allowed to use any method for channel prediction. Thereby UE must evaluate channel prediction error on current known DM-RS symbols. Based on that evaluation, UE computes two metrics: time-domain prediction error and frequency-domain prediction error (e.g., “Normalized Mean Squared Error”, “NMSE”) with the following formula:

$${NMSE}_{time} = ( \frac{1}{{N}_{time}^{DM - RS}} ) {\sum }_{{}_{l ∈ ℒ} DM - RS} \vert {h}_{k , l}^{pred} - {h}_{k , l}^{curr} \vert$$

$${NMSE}_{freq} = ( \frac{1}{{N}_{time}^{DM - RS}} ) {\sum }_{{}_{k ∈ 𝒦} DM - RS} \vert {h}_{k , l}^{pred} - {h}_{k , l}^{curr} \vert$$

As could be found in the specification,

$${h}_{k , l}^{pred}$$

means UE-predicted channel (not using current slot DM-RS symbols) on the (k,l)^{th} resource element;

$${h}_{k , l}^{curr} \vert$$

means UE-predicted channel (only using current slot DM-RS symbols) on the (k,l)^{th} resource element;
[symbol] CDM-RS is a set of time-domain symbol indices which are assigned for DM-RS symbols according to the current DM-RS pattern;
[symbol] DM-RS is a set of frequency-domain symbol indices which are assigned for DM-RS symbols according to the current DM-RS pattern; and

$${N}_{time}^{DM - RS} = \vert {ℒ}^{DM - RS} \vert$$

is the total number of time-domain symbols in the slot assigned for DM-RS symbols in the current DM-RS pattern; and

$${N}_{freq}^{DM - RS} = \vert {𝒦}^{DM - RS} \vert$$

is the total number of time-domain symbols in the slot assigned for DM-RS symbols in the current DM-RS pattern.

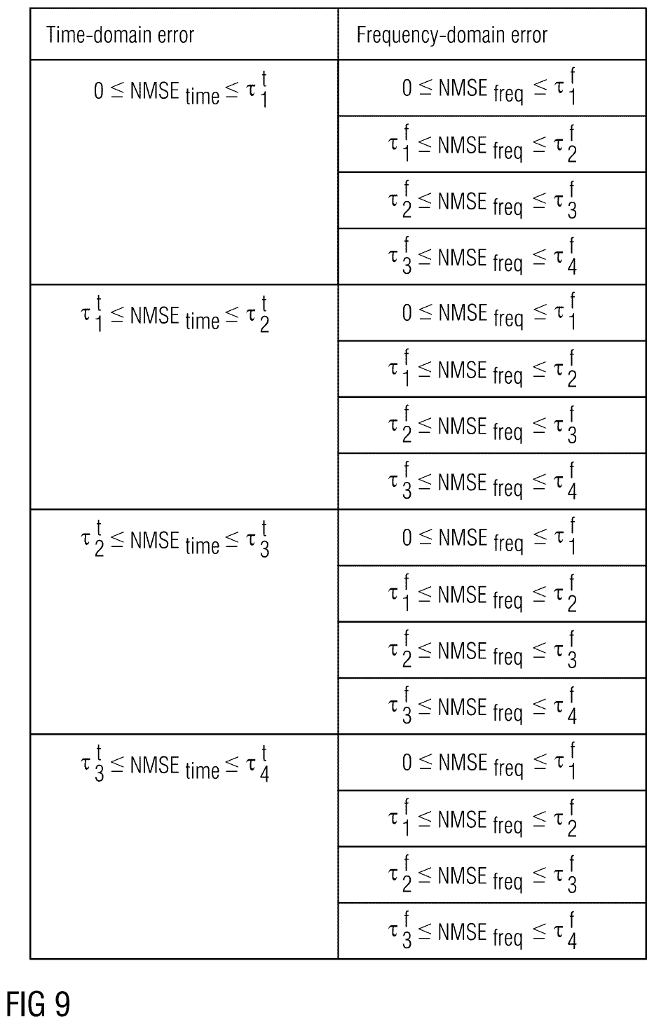

FIG. 9 shows an example of mapping from Error Evaluation to DM-RS Density. The columns comprise a quantization of time-domain (left column) and frequency domain (right column) error metrics into different ranges. A mapping from each combination of quantized error metrics to next DM-RS pattern has to be specified. For that, two ways are proposed: As option 1, the index of next DM-RS pattern is specified for each combination. This way does not depend on current DM-RS pattern. Option 2 is to specify the next DM-RS pattern for each (current) DM-RS pattern and time-frequency error metric combination.

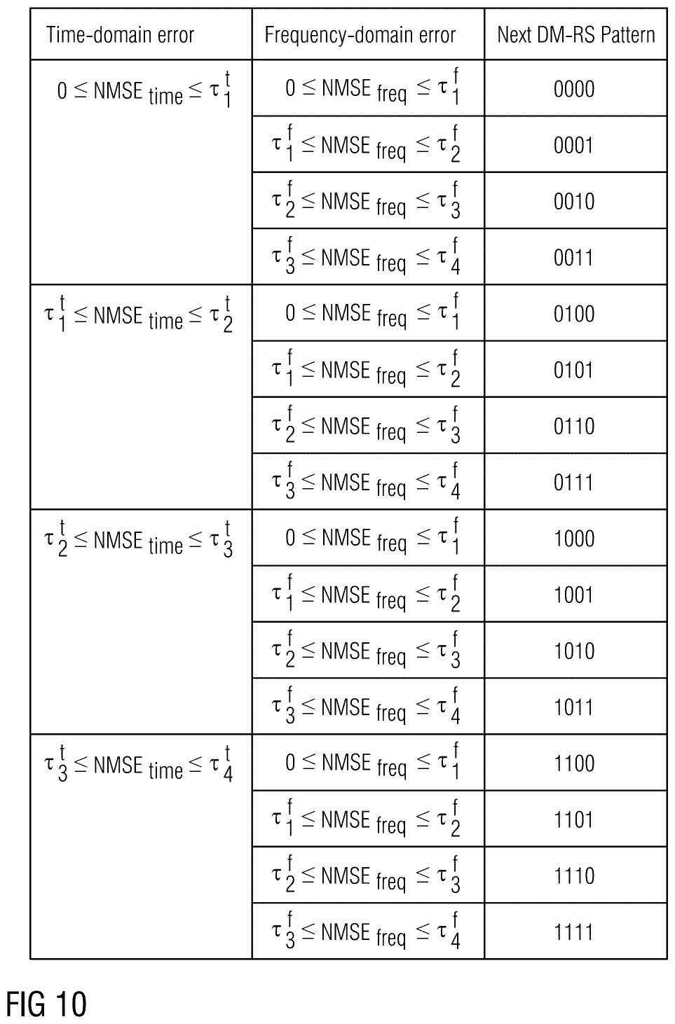

The list shown in FIG. 10 is an example for option 1. As one could find from the list, each combination of quantized error is mapped to a specific index.

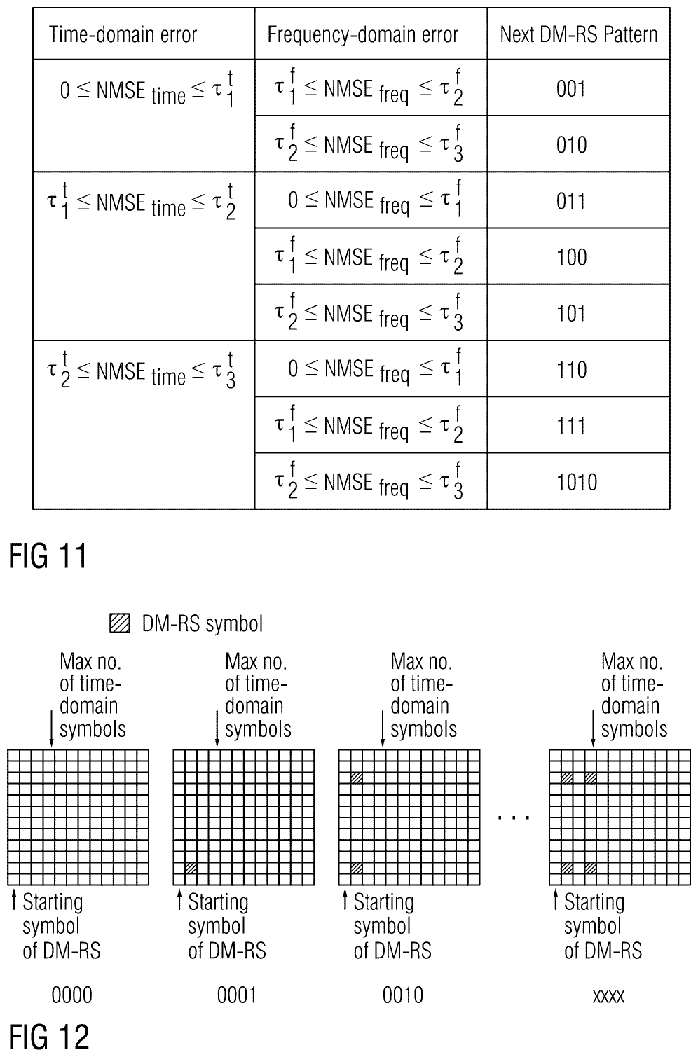

In contrast, FIG. 11 shows mapping from Error to DM-RS Density under option 2. For each combination of time-domain-error and frequency-domain-error the table specifies a specific DM-RS pattern. This option grants more flexibility, whereby the table has to be stored in memory.

Following a method is described how UE may find an indication to change DM-RS density: In case, current DM-RS density is zero, UE sends no indication/request except the HARQ ACK/NACK. But, if current DM-RS density is non-zero, the UE may indicate with indication part of uplink-control-information (UCI) transmitted on PUCCH or multiplexed with PUSCH by a single bit whether density needs to be changed or not, whereby “0” might be used for “no change” and “1” for “change”. If density needs to be changed, the nature of change has to be indicated by a defined number of bits, i.e. whether a new pattern and which pattern has to be used or whether and how much the current density has to be increased or decreased. Additionally, the UE may indicate the time, from which the new DM-RS density needs to be effective (in milliseconds or in terms of slots/frames) and the proof of feasibility of the DM-RS density/pattern (e.g. UE can indicate channel prediction error directly). If density does not need to be changed, no additional bits in indication are necessary.

The remaining figures illustrate examples of indication by UE.

FIG. 12 illustrates a first option of direct Indexing. With a four-bit index “0000”, . . . “XXXX” a pattern of DM-RS within the boundaries between starting symbol and maximum number of time domain symbols is directly signaled. Each pattern corresponds to a specified DM-RS density.

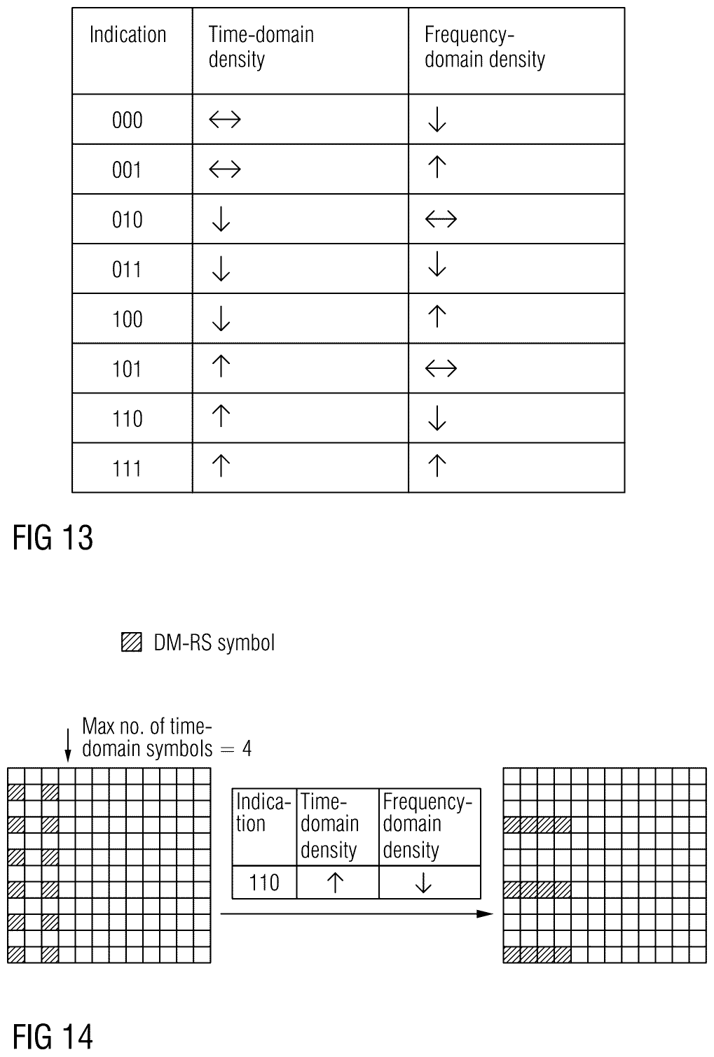

FIG. 13 illustrates a second option i.e. indexing one of the patterns close to the current pattern. As one may get from the table for each pattern there are a certain number of closest patterns. The bits indicate which of the “closest” patterns should be used as next, whereby ↔ means “no change”, ↓ “decrease” and ↑ “increase”.

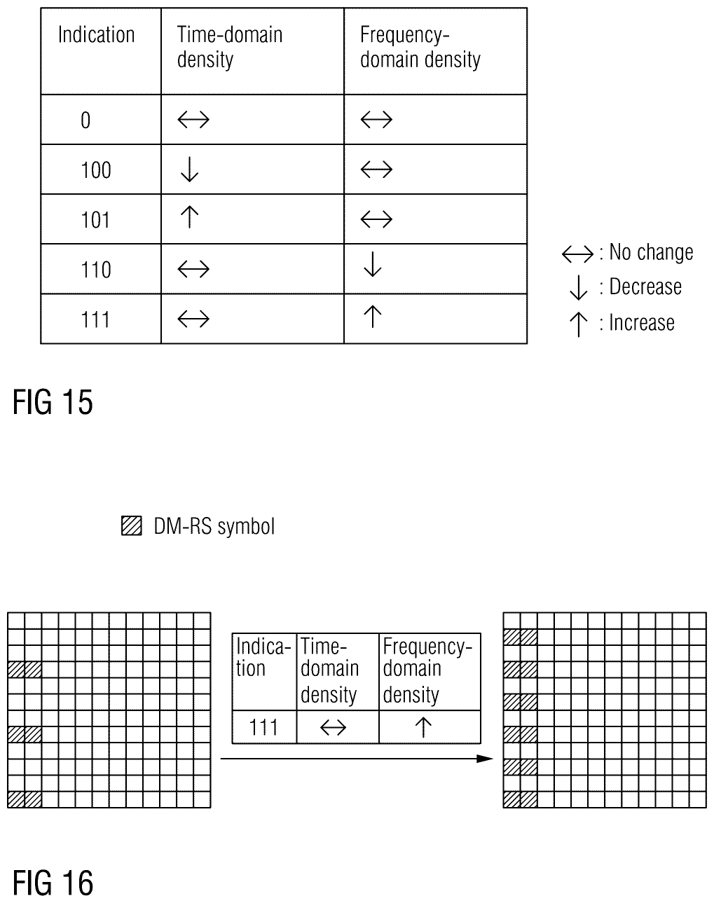

A similar indication is illustrated in FIG. 14, which allows the change of density in time and frequency domain, as well as in FIG. 15, where density change only in one domain at a time is possible. In the latter case a first single bit may indicate whether the density needs to be changed or not. A second single bit may indicate if time-domain density or frequency-domain density needs to be changed (e.g., 0: time-domain, 1: frequency-domain). A third single (or more) bit(s) may indicate(s) an increase or a decrease (e.g., 0: decrease, 1: increase or 00: decrease by two steps, 01: decrease by one step, 10: increase by one step, 11: increase by two steps, etc.). FIG. 16 illustrates a concrete example of the latter case.

1. A method to adapt a Demodulation Reference Signal (DM-RS) density in a wireless communication network, the method comprising:
submitting, by a receiver, especially a user equipment (UE), a request to the a transmitter, especially to a base station, to change the DM-RS density;
monitoring, by the transmitter, feedback of the receiver relating to a quality of reception; and
deciding, by the transmitter, in dependence of the feedback, whether to indicate a change of the DM-RS density.

2. The method according to claim 1, further comprising:
sending, by the receiver, a request to the transmitter to turn off DM-RS signals;
monitoring, by the transmitter, Hybrid Automatic Repeat Request protocol (HARQ) feedback of the receiver and deciding, by the transmitter, to change the DM-RS density for the receiver in dependence of the HARQ feedback of the receiver;
whereby the transmitter indicates to turn off DM-RS signals in case of HARQ ACK feedback or
the transmitter indicates to restore the DM-RS if the transmitter receives HARQ NACK feedback from the receiver;
whereby when DM-RS signals are turned off, the receiver uses blind decoding.

3. The method according to claim 1, whereby the transmitter decides to change the DM-RS density and indicates the change in dependence of the feedback based on an error evaluation and, if available, in dependence of other feedback related to channel state information.

4. The method according to claim 3, characterized in that, in case the DM-RS density is zero, the transmitter makes a decision based on the ACK/NACK feedback, potentially in combination with other types of feedback from the receiver, on whether to increase the DM-RS density.

5. The method according to claim 3, whereby
the receiver performs an error evaluation with a current DM-RS density,
based on the evaluation, the receiver sends a request to the transmitter to change the current DM-RS density,
the transmitter indicates a change of DM-RS density,
whereby, in case of a change in the DM-RS density, the receiver uses a new DM-RS density when performing data demodulation.

6. The method according to claim 5, whereby the receiver uses, for the error evaluation, a prediction accuracy on the known RSs or another suitable metric known to both the transmitter and the receiver.

7. The method according to claim 6, whereby, after error evaluation, the UE selects an indication to be fed back to the transmitter based on a mapping between an error and the a DM-RS pattern change.

8. The method according to claim 7, whereby the mapping between the error and the DM-RS pattern change is known to both the transmitter and receiver, via a pre-configuration between the transmitter and the receiver, or a system information message sent by the transmitter to the receiver, or by of being fixed in the specification.

9. The method according to claim 8, whereby ordered patterns with different time and/or frequency-domain densities are defined.

10. The method according to claim 9, whereby the ordered patterns are fixed for all receivers, or for each type of receiver, or for each single receiver.

11. The method according to claim 9, whereby a single pre-defined pattern is indicated by submitting a respective index or by indicating whether a current pattern should change to a next higher density pattern, or a next lower density pattern, in time and/or in frequency.

12. The method according to claim 2, whereby, if a current DM-RS density is zero, then the transmitter makes a decision based on the ACK/NACK feedback received, potentially in combination with other types of feedback from the receiver, on whether to change the density even without an explicit request from the receiver.

13. The method according to claim 1, whereby a method of error evaluation is specified, and the receiver uses the specified error evaluation method to select and feedback an indication back to the transmitter.

14. A system for adapting a Demodulation Reference Signal (DM-RS) density in a wireless communication network, the system comprising:
a receiver, especially a user equipment (UE), configured to submit a request, for changing the DM-RS density, to a transmitter, especially to the base station, and
a transmitter configured to monitor feedback of the receiver relating to the quality of reception, and configured to decide, in dependence of the feedback, whether to indicate a change of the DM-RS density.

15. A receiver, especially a user equipment (UE), for adapting a Demodulation Reference Signal (DM-RS) density in a wireless communication network, the receiver being configured to submit, to a transmitter, a request for changing the DM-RS density thereby causing the transmitter to monitor feedback of the receiver relating to a quality of reception and to decide, depending on the feedback, whether to indicate a change of the DM RS denssity.

16. A transmitter, especially a base station, for adapting a Demodulation Reference Signal (DM-RS) density in a wireless communication network, the transmitter being configured to monitor feedback of a receiver relating to the quality of reception, and being configured to decide, in dependence of the feedback, whether to indicate a change of DM-RS.
